(19) United States
(12) Patent Application Publication
(10) Pub. No.: US 2011/0060803 A1
(43) Pub. Date: Mar. 10, 2011

(54) Message Notification Campaigns

(75) Inventors: David S. Barlin, Newcastle, WA (US); Michael C. Kunz, Seattle, WA (US); Chad S. Estes, Woodinville, WA (US)

(73) Assignee: Microsoft Corporation, Redmond, WA (US)

(21) Appl. No.: 12/945,671

(22) Filed: Nov. 12, 2010

Related U.S. Application Data
(63) Continuation-in-part of application No. 12/428,620, filed on Apr. 23, 2009.

(51) Int. Cl. G06F 15/16

(52) U.S. Cl. 709/206

(57) ABSTRACT

Techniques for message notification campaigns are described. In an implementation, a messaging service may process a message received for delivery to a client to determine one or more notifications regarding the message to be sent to the client. The one or more notifications may be designated by way of a notification campaign that is associated with a sender of the message or directly with the message itself The messaging service may parse metadata fields within the message to identify the sender and/or other data sufficient to determine notifications designated to take place regarding the message. A variety of different types of notifications regarding a message may be sent to a client. The messaging service may cause one or more notifications to be sent to the client in conjunction with various resources from a service provider in addition to delivery of the message to the client.

### PRIORITY

This Application is a Continuation-In-Part of and claims the benefit of priority under 35 U.S.C. §120 to U.S. patent application Ser. No. 12/428,620, filed on Apr. 23, 2009 and titled “Advertisement Coordination,” the disclosure of which is incorporated herein by reference in its entirety.

### BACKGROUND

Marketing by email and other forms of messaging is attractive to business entities because of the broad reach, rich targeting, and effectiveness that is associated with this kind of marketing. Unfortunately, it may be difficult to get the attention of consumers who may be interested in the promotions. Moreover, messages may be filtered as junk and/or consumers may choose to ignore even messages with highly valuable/relevant promotions if the messages lack “eye-catching” subject lines or other ways of getting the user's attention. Therefore, business entities may spend a significant amount of time and money trying to develop messages and especially subject lines that are attractive to consumers. Still, there are limited tools available to business entities and consumers alike that may assist in exposing highly valuable/relevant messages to consumers and signaling consumers regarding the messages they may be most interested in.

### SUMMARY

Techniques for message notification campaigns are described. In an implementation, a messaging service may process a message received for delivery to a client to determine one or more notifications regarding the message to be sent to the client. The one or more notifications may be designated by way of a notification campaign that is associated with a sender of the message or directly with the message itself The messaging service may parse metadata fields within the message to identify the sender and/or other data sufficient to determine notifications designated to take place regarding the message. A variety of different types of notifications regarding a message may be sent to a client. The messaging service may cause one or more notifications to be sent to the client in conjunction with various resources from a service provider in addition to initiating delivery of the message to the client.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example environment that is operable to provide message notification campaigns.

FIG. 2 is an illustration of an example scenario to process a message in accordance with one or more embodiments.

FIG. 3 is illustration of an example of an example user interface configured to display notifications in accordance with message notification campaigns.

FIG. 4 is a flow diagram depicting an example procedure in which notifications regarding a message are sent in accordance with a notification campaign.

FIG. 5 is a flow diagram depicting an example procedure in which a message is processed to determine notifications to take place for the message.

FIG. 6 is an illustration of an example computing system in accordance with one or more embodiments.

### DETAILED DESCRIPTION

Overview

Marketing by email and other forms of messaging is attractive to business entities because of the broad reach, rich targeting, and effectiveness that is associated with this kind of marketing. Business entities may spend a significant amount of time and money trying to develop messages and especially subject lines that are designed to get the attention of consumers who may be interested in the promotions. Still, there are limited tools available to business entities and consumers alike that may assist in exposing highly valuable/relevant messages to consumers and signaling consumers regarding messages they may be most interested in.

Techniques for message notification campaigns are described. In an implementation, a messaging service may process a message received for delivery to a client to determine one or more notifications regarding the message to be sent to the client. The one or more notifications may be designated by way of a notification campaign that is associated with a sender of the message or directly with the message itself The messaging service may parse metadata fields within the message to identify the sender and/or other data sufficient to determine notifications designated to take place regarding the message. In at least some cases, two or more different types of notifications regarding a message may be sent to a client. The messaging service may cause appropriate notifications to be sent to the client in addition to initiating delivery of the message to the client.

In the discussion that follows, a section titled “Example Environment” describes an example environment and devices, which may be employed to provide message notification campaigns in various embodiments. Next a section titled “Message Notification Campaign Examples” describes some example implementation details regarding notifications that may be provided to a client in accordance with techniques for message notification campaigns. Following this, a section titled “Example Procedures” describes example techniques related to message notification campaigns in accordance with one or more embodiments. Last, a section titled “Example System” is provided and describes example computing systems and devices that may be used to implement one or more embodiments of techniques for message notification campaigns.

Example Environment

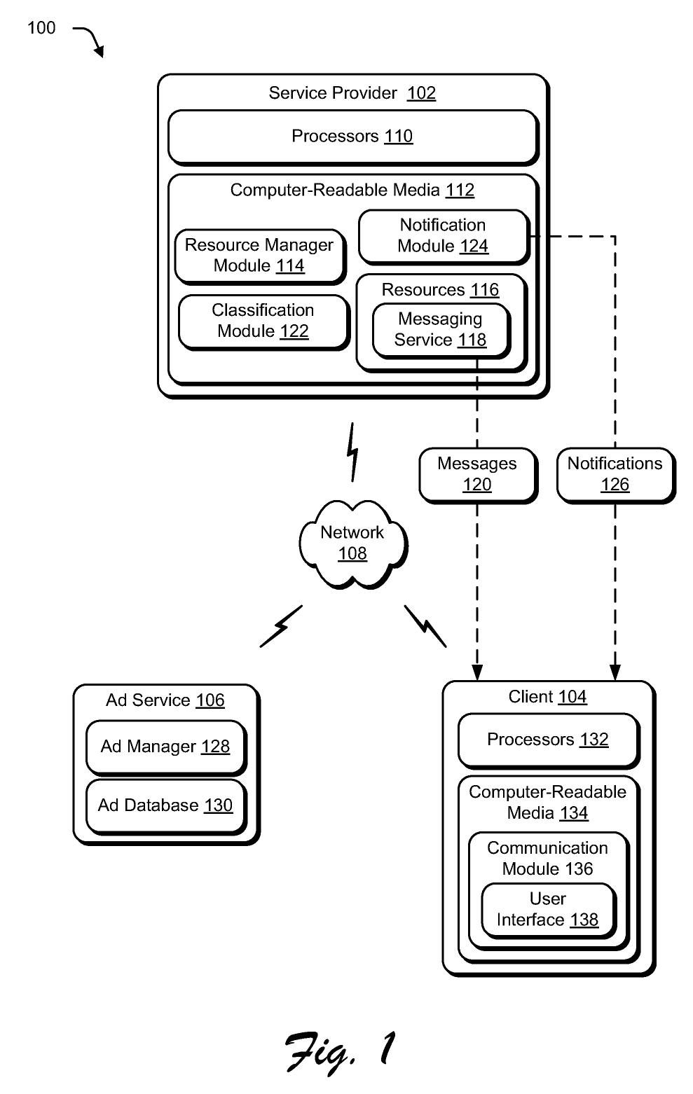

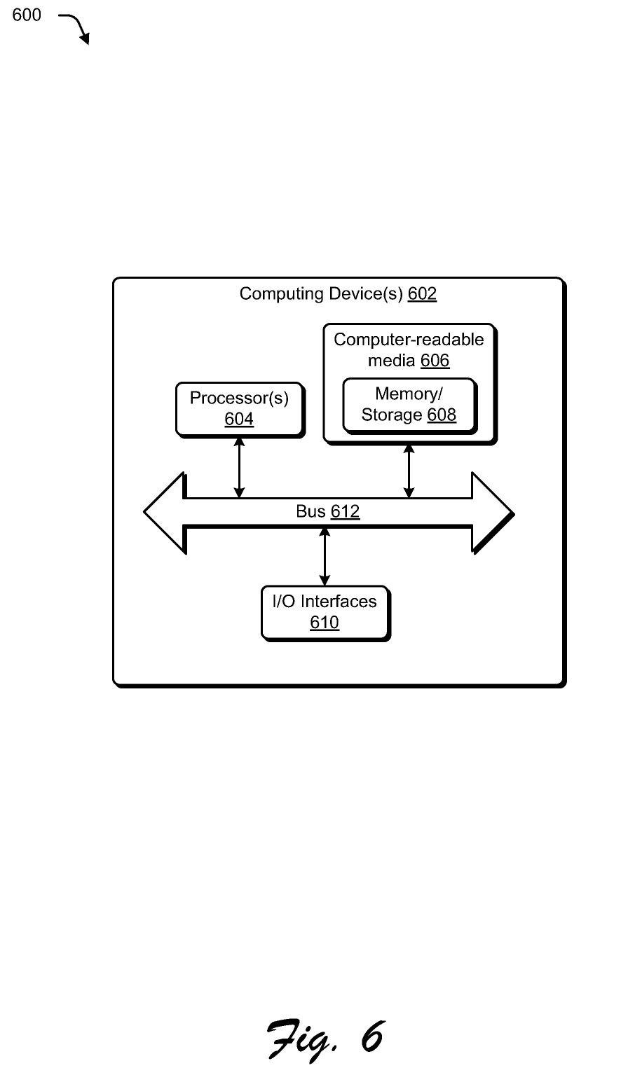

FIG. 1 is an illustration of an example environment 100 that is operable to provide message notification campaigns. The illustrated environment includes a service provider 102, a client 104, and an ad service 106 that are communicatively coupled, one to another, over a network 108. Although the network 108 is illustrated as the Internet, the network may assume a wide variety of configurations. For example, the network 108 may include a wide area network (WAN), a local area network (LAN), a wireless network, a public telephone network, an intranet, and so on. Further, although a single network 108 is shown, the network 108 may be configured to include multiple networks. The service provider 102, client 104, and ad service 106, may be implemented by respective computing systems, which each may incorporate one or more devices and may be configured in a variety of ways. Some example computing systems and devices are described below in relation to FIG. 6.

The client 104 may be configured as a computing device that is capable of communicating over the network 108, such as a desktop computer, a mobile station, an entertainment appliance, a set-top box communicatively coupled to a display device, a wireless phone, a game console, a tablet computer, a netbook, and so forth. Thus, the client 104 may range from a full resource device with substantial memory and processor resources (e.g., personal computers, game consoles) to a low-resource device with limited memory and/or processing resources (e.g., traditional set-top boxes, hand-held game consoles, embedded devices, and so forth). The client 104 may also relate to an entity that operates the client 104. For instance, a client 104 may represent multiple different types of devices that may be used at different times to access service accounts for an entity that operates the client 104. In other words, client 104 may describe a logical client that include software as well as hardware that is used to execute the software, e.g., one or more processors.

In the following discussion, a referenced component, such as service provider 102, may refer to one or more entities, and therefore by convention reference may be made to a single entity (e.g., the service provider 102) or multiple entities (e.g., the service providers 102, the plurality of service providers 102, and so on) using the same reference number.

The service provider 102 may have one or more processors 110 and one or more computer-readable media 112, which may be configured in various ways. Computer-readable media as used herein may include, by way of example and not limitation, all forms of volatile and non-volatile memory and/or storage media/devices that are typically associated with a computing device. Such media may include ROM, RAM, flash memory, hard disk, removable media, fixed logic circuits, and the like. Computer-readable media may include both “computer-readable storage media” and “communication media,” examples of which may be found in the discussion of the example computing system of FIG. 6.

The service provider 102 is depicted as storing a resource manager module 114 on the computer-readable media 112 that is executable via the one or more processors 110. The resource manager module 114 represents functionality operable by the service provider 102 to manage various resources 116 that may be made available over the network 108. For example, various resources 116 may be provided via web pages or other user interfaces that are communicated over the network for output by one or more clients. The resource manager module 114 may manage access to the resources 116, performance of the resources, configuration of webpages to provide the resources 116, and so on. The service provider 102 may represent one or more server devices used to provide the various resources 116.

One particular example of a resource 116 that may be provided by a service provider 102 is a messaging service 118 as depicted in FIG. 1. The messaging service 118 is representative of functionality operable to manage communication of messages 120 between clients 104. The messaging service 118 may be operated alone and/or in conjunction with other services to provide functionality for one or more different types of messaging. By way of example and not limitation, the multiple different types of messaging provided by the messaging service 118 may include email, text messages, application and/or operating system notifications, social networking notices and invites, instant messaging, voice messages, peer-to-peer messaging, and so forth. Accordingly, messages 120 may represent various forms of messages corresponding to one or more of the different types of messaging provided by the messaging service 118.

More generally, resources 116 made accessible by a service provider 102 may include any suitable combination of services and/or content typically made available over a network by one or more providers. Some examples of services include, but are not limited to, a search service, an email service to send and receive email, an instant messaging service to provide instant messages between a client 104 other clients, and an authentication service to control access of clients to the resources 116. Additional examples of services include a shopping service, a weblog service, productivity service, a news service, and an advertisement service to name a few. Content may include various combinations of text, video, ads, audio, multi-media streams, animations, images, web pages, web applications, device applications, content for display by a browser or other device application, and the like.

An authentication service may be provided by the resource manager module 114 to authenticate clients to access various resources 116 that may be provided by one or more of the service providers 102. For example, a client 104 may provide a username and password that is authenticated by the authentication service. When the authentication is successful, the authentication service may pass a token, or other suitable data, to enable access to corresponding resources 116. Authentication of the client 104 to an account (e.g., “a single sign-on”) may provide access to a single corresponding service provider 102, service, and/or resource 116. Additionally or alternatively, a single authentication may correspond to multiple resources, such that authentication to a single account provides access to many service providers 102 and/or to many resources 116 including an entire suite of services.

The service provider 102 is further depicted as storing a classification module 122 and a notification module 124 that may be executable via the one or more processors 110 to implement “server-side” aspects of message notification campaigns described herein. Although illustrated a separate modules, the classification module 122 and/or the notification module 124 may alternatively be combined together and/or implemented as components of the messaging service 118. The classification module 122, for instance, represents functionality operable to examine messages 120 and parse the messages to determine messages that are eligible for enhanced notifications. The notification module 124 represents functionality operable to cause one or more notifications 126 regarding a message 120 to be sent to a client 104 in various forms as appropriate. For example, notification module 124 may determine whether a sender of a message 120 has enabled notifications 126 by purchasing, subscribing to, or otherwise enabling a notification campaign. Thus, notification module 124 may be configured to cause notifications 126 to be communicated in various ways to the client 104 in accordance with a notification campaign associated with a message 120 and/or sender of the message 120. Further details regarding operation of a classification module 122 and a notification module 124 to implement aspects of message notification campaigns may be found in relation to the following figures.

The ad service 106 may include an ad manager 128 that represents functionality to select ads to serve to a client 104 in response to an ad request. For example, the ad manager 128 may select ads from an ad database 130 to serve in conjunction with messages 120, webpages, downloaded content items, and/or various resources 116 made available via the service provider 102. Typically, ads may be selected for presentation to a client 104 that are relevant to the client using various contextual information, including but not limited to characteristics of the client 104 (e.g., a client profile) and/or characteristics of messages 120 and/or resources 116 with which the client 104 interacts. For example, a travel related ad may be served to a client 104 in conjunction with a travel website that is output to the client. In another example, a sporting goods related ad may be served to a client 104 in conjunction with an email from a sporting goods retailer. Although, illustrated as a standalone service, the ad service 106 may be provided as a component of the service provider 102.

The ad manager 128 may also represent functionality operable to provide and manage notification campaigns as described above and below. For instance, the ad service may facilitate formation of associations between business entities (e.g., entities that send marketing, commercial, and/or promotional messages to clients) and different notification campaigns available from the service provider 102 and/or ad service 106. The associations may be stored in an ad database 130. For example, a business entity may interact with the ad service 106 to establish an account and make selections to sign-up for ad/marketing related features including notification campaigns.

In one example, the ad service 106 may expose one or more registration user interfaces that enable business entities to purchase different ad/marketing related features individually or in packages. Through the notification campaigns, the business entities may select from and subscribe to multiple different types of available notifications and designate criteria to control the notifications that are sent for different messages. An association of a business entity with a notification campaign may be formed according to selections made via the one or more registration user interfaces. Details regarding various notifications that may be made available through notification campaigns may be found in relation to the following figures.

The example client 104 is depicted as having one or more processors 132 and computer-readable media 134. The computer-readable media 134 is also depicted as storing a communication module 136 that is executable via the one or more processors 132. The communication module 136 represents functionality to enable various communications over the network 108. For example, the communication module 136 may be implemented as a browser or other suitable application to obtain and output webpages and/or other user interfaces 138 from the service provider 102 over the network 108. The communication module 136 may also represent a component of another application used to obtain one or more resources 116 from the service providers 102 that may be presented and interacted with via different user interfaces 138 output via the communication module 136. Thus, the communication module may provide various interactions with service providers 102 and/or resources 116. Examples of such interaction include, but are not limited to, communicating one to another, navigating content, searching webpages, accessing resources 116, interacting with a social networking site, performing searches, downloading content, using various services, managing accounts, and so forth.

Having considered devices and components of an example environment, consider now example implementation details for message notification campaigns that may be implemented in the environment using the example components, as well as in other environments.

Message Notification Campaign Examples

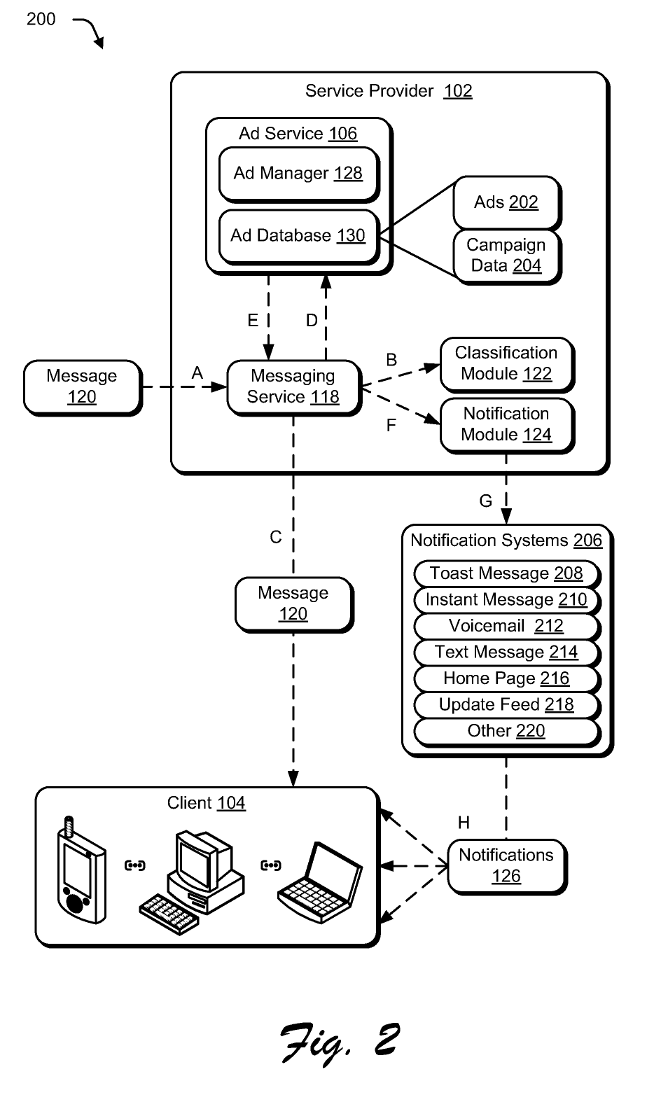

Consider now a discussion of example implementation details of message notification campaigns that may be employed in one or more embodiments. These details are described in relation to an example scenario 200 that is illustrated in FIG. 2. In particular, the example scenario 200 of FIG. 2 represent various example acts that may occur in the course of processing a message 120 for delivery to a client 104 and that are designated using different letters.

A message 120 for delivery to a client 104 is received by the service provider 102 (Act A). At the service provider 102, a messaging service 118 may process the message to route the message to the appropriate client 104 or otherwise initiate delivery to the client. In addition, the messaging service 118 may make use of a classification module 122 to classify the message 120 (Act B). Delivery of the message 120 to a client 104 may also be initiated (Act C). The messaging service 118 may initiate message delivery simultaneously with message classification or immediately after classification in a push delivery model. Operations to route a message, direct message delivery, or otherwise cause delivery of messages may also occur at some time after classification, such as responsive to a client 104 request to access a messaging account with a service provider 102. A message 120 may be delivered, for example, by routing the message to a messaging account with a messaging service 118 or other service available from a service provider 102.

To classify messages 120, the classification module 122 may examine messages 120 and parse content and/or fields of the messages to determine messages that are eligible for enhanced notifications. The classification module 122 may also determine contextual information associated with messages 120 that may be used to match messages to selection criteria for notifications and/or to select ads that are relevant to the message 120.

Classifying a message 120 may involve extracting data contained in one or more message metadata fields within a message. The classification module 122 may be configured to parse data included in one or more message metadata fields in order to ascertain a message sender, a notification campaign, and/or an ad campaign corresponding to the message 120. By way of example, message metadata fields may include header fields in a message header such as a “From” field, a “Subject” field, a “To” field, and a “Date” field. Header fields are typically visible in a message inbox and/or along with a corresponding message 120 when the message 120 is displayed by the communication module 136. In addition, data may also be extracted from one or more embedded metadata fields included within the message 120. The embedded metadata fields may be configured to include additional information regarding properties and characteristics of a message 120. The embedded metadata fields may or may not be made automatically visible when a message 120 is displayed.

A message sender may relate to a business entity that sends marketing messages to clients 104. Data extracted from a message suitable to identify the business entity may include a business name, a domain name, a sender messaging address, and/or an account identifier assigned to the business entity. For instance, a “From” field may include a sender messaging address. In at least some embodiments, a domain name may be determined by parsing the sender messaging address. A message 120 may also be configured to include a business name, account identifier, or other identifying information in a “Subject” field. Additionally or alternatively, data suitable to identify the business entity may be included in one or more header or embedded metadata fields specifically designated to contain particular information (e.g., custom fields). For example, a message 120 may be configured to include custom fields for a business name, an account identifier, a domain name, and/or other identifying data.

Metadata fields as just described may also be configured to contain identifiers (IDs) suitable to identify a notification campaign and/or an ad campaign associated with a message 120. For instance, a campaign ID may be included in a header field such as the “Subject” field or in a custom embedded metadata fields. The campaign ID may be sufficient to identify a notification campaign, a particular ad, and/or an ad campaign for a message 120 and a corresponding business entity that is associated with the campaign ID. In another example, one or more custom metadata fields may be defined to directly signify types of notification to take place for a message 120. For instance, a field <MessengerToastSubject> may be defined to indicate whether to send an instant messaging toast notification that includes the subject line of a message 120. If the value of the field in a message is “True,” then the subject line may be passed in an instant messaging toast notification. Naturally, one or more such custom metadata fields may be defined for different available types of notifications described herein.

Additionally or alternatively, classifying a message 120 may involve scanning data from content contained in the body of the message 120. For instance, the classification module 122 may be configured to scan content of a message looking for keywords, identifying details, contextual clues, and/or other data to determine the type of message, a sender identity, one or more subject matter categories for the message, and so forth.

Additional details regarding techniques to serve ads to a client 104 in accordance with an identified message sender and/or ad campaign may be found in U.S. patent application Ser. No. 12/428,620, which is the parent application of the present application referenced above. The following discussion provides further details regarding notifications and notification campaigns that may be associated with a business entity and/or messages 120 sent by the business entity.

Note that a business entity associated with a message 120 may or may not have subscribed to a notification campaign that enables enhanced notifications for messages that are sent by the business entity. The classification of messages 120 using metadata fields and/or or content scanning may assist in matching messages 120 to corresponding notification campaigns. In particular, sender identity and/or a campaign ID ascertained through the classifications may be used to perform a lookup of and/or a request for information corresponding to the sender identity and/or campaign ID. This may include ascertaining a notification campaign that is associated with a business entity using the sender identity and/or campaign ID.

In one example, the service provider 102 through the messaging service 118, may ascertain a notification campaign associated with a business entity through interaction with an ad database 130 managed by an ad service 106. In FIG. 2, the ad service 106 is depicted as being implemented by the service provider 102, although the ad service 106 may also be implemented separately as illustrated in FIG. 1. The ad database 130 managed by the ad manager 128 may store various ads 202 that may be served with resources 116 and campaign data 204 that may associate business entities with notification campaigns. In particular, the campaign data 204 may reflect associations of business entities with notification campaigns, contract status of the campaigns (e.g., is payment for a campaign up-to-date, has the contract expired, and so forth), and details for particular campaigns including the types of notifications that are enabled for the campaign and criteria defining when and/or for what messages 120 enhanced notifications are to be sent by the service provider 102.

Thus, given classification data determined in the above manner for the example message 120, the messaging service 118 may look-up or make a request to obtain campaign data 204 from the ad service 106 that corresponds to the classification data (Act D). For instance, a sender identity or campaign ID may be provided to the ad service 106 and in response the ad service 106 may return campaign data 204 having details regarding a corresponding notification campaign (Act E).

The messaging service 118 may use the details that are obtained from the ad service 106 to direct the notification module 124 to provide notifications 126 in accordance with the notification campaign (Act F). For example, the notification module 124 may be configured to use details for a notification campaign to determine one or more types of notifications to take place for a given message. In general, this may include using classification data and/or notification campaign details to determine message by message (1) eligibility of individual messages for different types of notifications and/or (2) authorizations for a business entity to obtain the eligible notifications (e.g., has the business entity paid for the notifications). If a message is not associated with a notification campaign, the message is ineligible for some reason, or the business entity in not authorized, the message 120 may be sent to the client without providing any notifications 126. Otherwise, notification module 124 may operate to cause appropriate notifications to be sent.

For instance, the notification module 124 may interact with one or more notification systems 206 to cause appropriate notifications 126 to be communicated to the client 104 (Act G). Under the direction of the notification module 124, the notification systems 206 provide the notification 126 to the client 104 (Act H). The one or more notification systems represent functionality operable to provide different types of notifications 126 using various techniques and forms of messaging. Although illustrated separately, the notification systems 206 may represent a component of the service provider 102, such as being part of an integrated messaging service 118 implemented by the service provider 102.

As shown in FIG. 2, examples of different types of notifications 126 that may be employed include notifications communicated as toast messages 208 for a messaging application, operating system, or other application, instant messages 210, voicemail messages 212, text messages 214, and the like. Notifications 126 may also be placed on a home page 212 associated with a client account (e.g., a client-specific start page provided by the service provider 102) or integrated with an update feed 218 for a client 104 such as a feed associated with a social network service. A variety of other 220 types of notifications are also contemplated.

One or multiple different types of notifications 126 may take place for a particular message. Notifications 126 may also be sent to multiple addresses associated with a client 104 or a corresponding account. Further, notifications 126 may be provided in conjunction with multiple services and/or other resources 116 available from a service provider 102. Thus, in addition to obtaining a message 120 through a messaging service 118, a client may obtain notifications 126 regarding the message in various ways and/or in conjunction with many different resources 116 from a service provider 102.

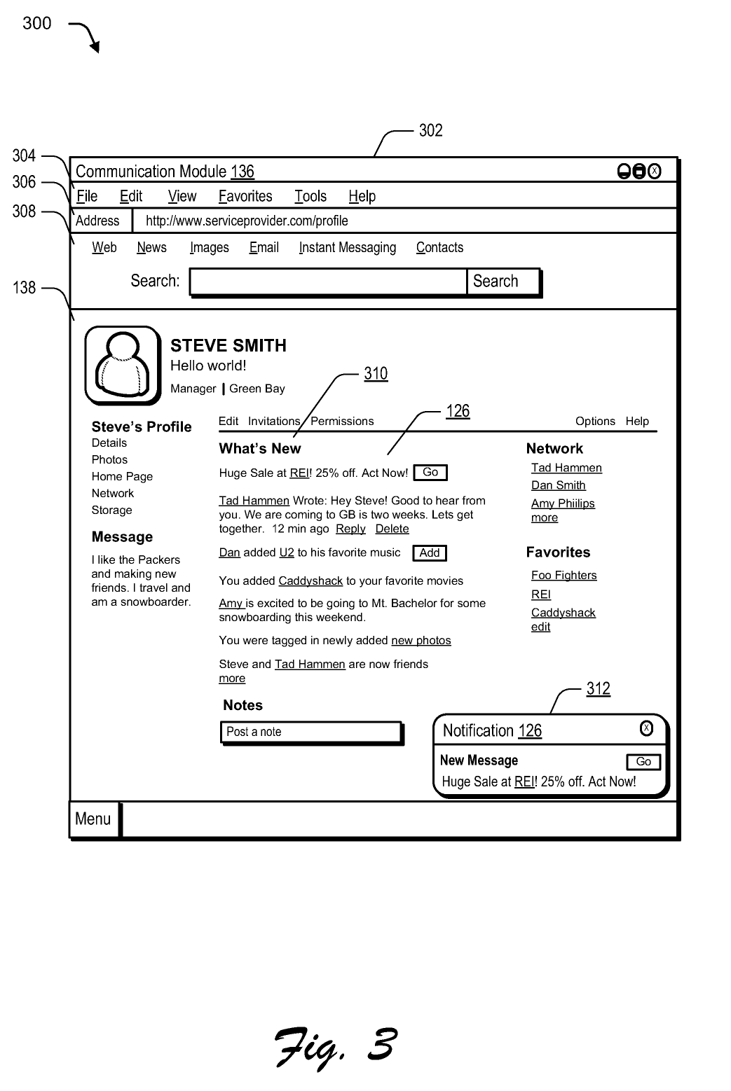

Referring now to FIG. 3, an implementation 300 is illustrated showing an example user interface 138 that includes one or more notifications 126 that may take place for a message 120 from a business entity in accordance with a notification campaign. The user interface 138 in this instance is illustrated as incorporated within a user interface 302 that may be provided by the communication module 136. For example, the communication module 136 may be configured as a browser operable to expose the user interface 302 to enable interaction with one or more service providers 102 and corresponding resources 116.

To provide the interaction with resources 116, the user interface 302 includes a menu bar 304, an address bar 306, and a search bar 308. The menu bar 304 is a portion of the user interface 302 that includes drop-down menus of commands, examples of which are illustrated as “file”, “edit”, “favorites”, “tools” and “help.” The address bar 306 is configured to receive inputs to navigate to particular network addresses and/or display current network addresses, from which, the client 104 has received content that is being displayed. The search bar 308 may be operable to conduct a variety of searches including searches for webpages, images, news, and so forth.

In the example of FIG. 3, the user interface 138 is configured as a social network profile page to enable interaction of a client 104 with a social network service. A comparable user interface 138 may also be configured for interaction with other services and/or resources 116. Although depicted as being part of the user interface 302 of a browser, a user interface 138 may also be provided by a standalone applications of the client 104, such as a standalone email client, an instant messaging client, a personal information management program, or a desktop social networking application, to name a few. In each case, the user interface 138 may be configured to display notifications 126 that are output through operation of a notification module 124 or otherwise provided by a service provider 102.

In particular, the user interface 138 includes an example notification 126 for a message 120 from an outdoor gear retailer that is incorporated within a “What's New” feed 310 provided by the social network profile page. Another example notification 126 configured as a toast message 312 is also depicted. Notifications 126 may be configured in a variety of ways. A notification 126 may include the subject line of a corresponding message or a portion thereof For instance, the example notifications 126 in FIG. 3 include the subject line “Huge Sale at REI! 25% off Act Now!” A notification 126 may also be configured to include a control or link that is selectable to navigate to the corresponding message 120. For instance, the “Go” button appearing with the example notifications 126 in FIG. 3 may be selectable to cause the browser to navigate to an email client page that expose an inbox and/or the particular message 120 corresponding to the notification. A notification 126 may also be customized with a theme related to the message 120 and/or a corresponding business entity. For instance, the example toast message 312 may be configured to express an outdoor theme related to the outdoor gear retailer using customized colors, logos, images, sounds, graphics, and so forth. By way of example, the example toast message 312 may incorporate a logo for the outdoor gear retailer, use a background image of snowy mountains, and so forth, to express the outdoor theme.

Having considered message notification campaign examples, consider now example procedures for message notification campaigns that may be implemented in the environment using the example components, as well as in other environments.

Example Procedures

The following discussion describes techniques for message notification campaigns that may be implemented utilizing the systems and devices described above and below. Aspects of each of the procedures may be implemented in hardware, firmware, software, or a combination thereof The procedures are shown as a set of blocks that specify operations performed by one or more devices and are not necessarily limited to the orders shown for performing the operations by the respective blocks. In portions of the following discussion, reference may be made to the example environment 100 of FIG. 1. In at least some embodiments, the following procedures may be performed by a suitably configured service provider, such as service provider 102 of FIG. 1 having a messaging service 118, classification module 122, and/or notification module 124.

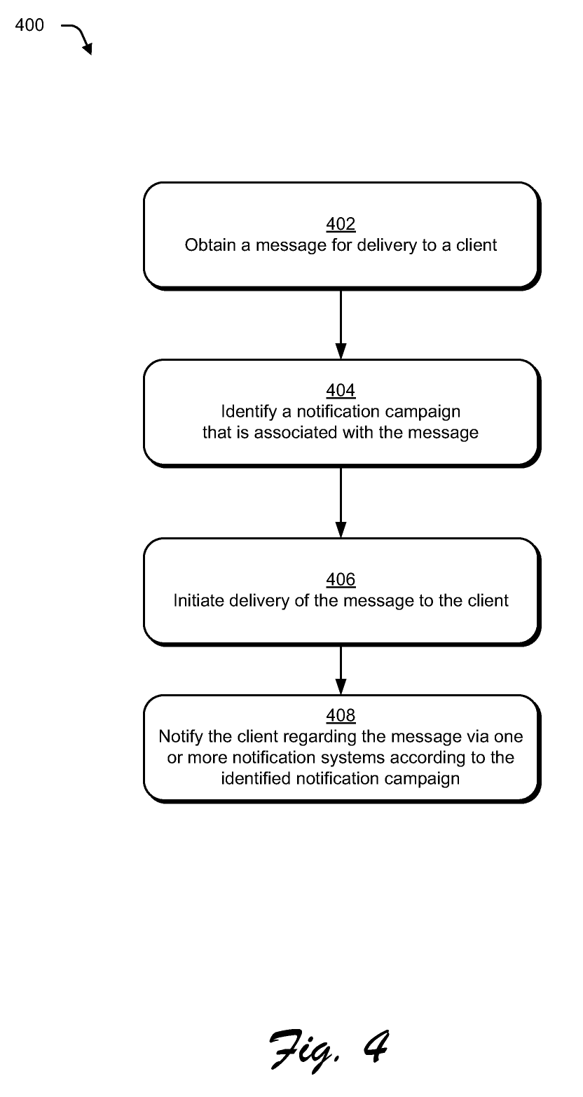

FIG. 4 depicts a procedure 400 in an example implementation in which notifications regarding a message are provided in accordance with a notification campaign. A message is obtained for delivery to a client (block 402). For example, a marketing message from a business entity, such as from a retail business or an online merchant site, may be received by a messaging service 118 at a service provider 102. For the purpose of example, assume a message 120 is obtained from “BuySportsStuff.biz,” which may be an online merchant selling sports related goods. The messaging service 118 may be configured to process the message 120 from “BuySportsStuff.biz” to route the message and determine whether to send notifications 126 regarding the message 120 to a client 104.

A notification campaign is identified that is associated with the message (block 404). A notification campaign may be identified in various ways. In one approach, metadata fields of a message 120 may be used to identify a corresponding message sender and/or campaign as discussed in relation to FIG. 2. Metadata fields may include standard and custom fields that carry information sufficient to determine a corresponding campaign. Custom fields may even be defined to directly signify particular types of notifications to take place for a message. Thus, notifications may be prompted by one or more metadata fields included in a message.

In another example approach, a sender identity determined by classifying a message 120 may be used to implement a notification campaign at an enterprise level using for instance a domain name, a business name from a field, email service provider name, or other sender identity data extracted from a message. In this approach, a notification campaign may be applied uniformly to messages that are associated with a particular business entity. For example, an enterprise level notification campaign for “BuySportsStuff.biz” may be configured to cause uniform notifications to occur for select messages sent by “BuySports Stuffbiz”.

In yet another approach, a service provider 102 may define one or more reputation-based notification campaigns. A sender identity and/or other data determined by classifying a message 120 may be used to establish a reputation for a corresponding business entity. Then a reputation-based notification campaign may be selected for the message 120 if appropriate based on the established reputation. In this approach, community-based reputation systems may be leveraged to determine the types of notifications to provide to a business entity. This may include using SPAM reports, social network recommendations, fan associations, and other client driven feedback regarding a business entity to establish the reputation.

Delivery of the message to the client is initiated (block 406). For example, the messaging service 118 may form communications, direct delivery by another component, and/or perform routing operations to initiate delivery of the marketing message from “BuySportsStuff.biz” to the intended recipient. The delivery of a message may be configured to occur at various times including before, during, or after processing of the message to identify a corresponding notification campaign. For example, a message 120 may be pushed to a client device or may be delivered (e.g., routed) to an inbox of an associated messaging account. A client 104 may then interact with the service provider 102 to access the messaging account and view messages 120, including the marketing message from “BuySportsStuff.biz”

The client is notified regarding the message via one or more notification systems according to the identified notification campaign (block 408). For example, a notification module 124 may be implemented to cause notifications 126 for a message 120 using one or more of the notification systems 206 as discussed previously. For instance, “BuySportsStuff.biz” may be associated with an enterprise level campaign designed to cause notifications by message toast 208 and through an update feed 218. In another case, the marketing message from “BuySportsStuff.biz” may include one or more custom fields that direct the notification module 124 and/or messaging service 118 to provide specific notifications 126, such as one or more of an instant message 210, a toast message 208, and a notification placed on a home page 216. Thus, a notification module 124 may send one or more notifications 126 as designated by a campaign that is associated with a message 120. Accordingly, a client 104 not only receives the marketing message from “BuySportsStuff.biz,” but also one or more notifications 126 that may include the subject line and/or other portions of the message 120, a link to the message 120, a custom theme related to “BuySportsStuff.biz” and so forth.

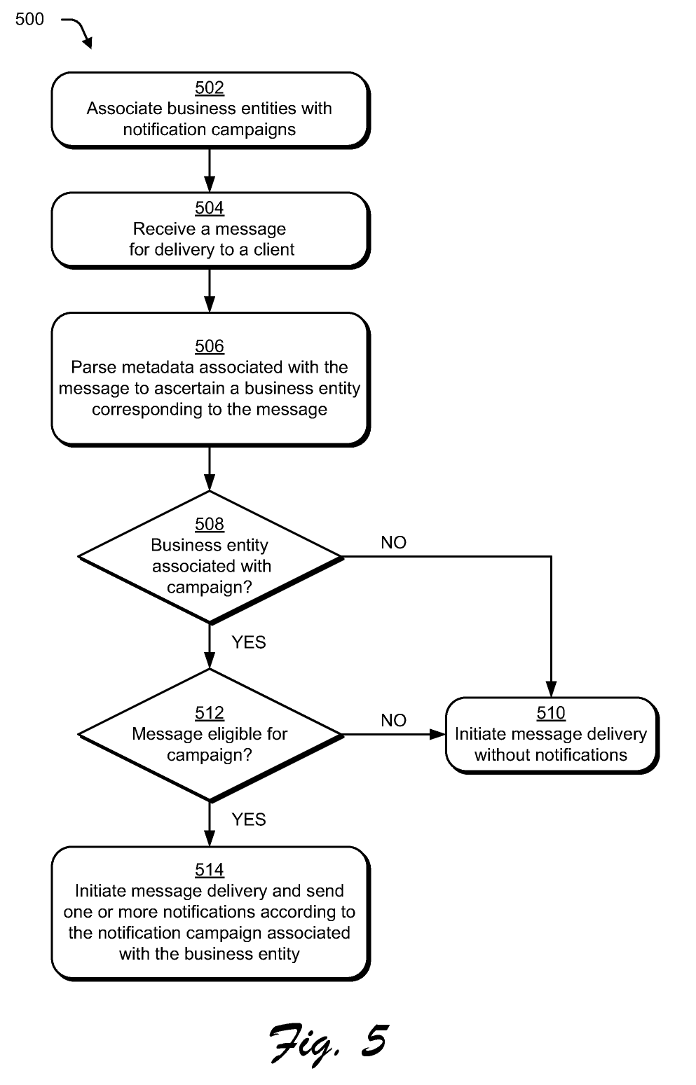

FIG. 5 depicts a procedure 500 in an example implementation in which a message is processed to determine notifications to take place for the message. For example, procedure 500 may be applied to an email message sent by a business entity to a client account with a messaging service 118 provided by a service provider 118. Procedure 500 is also applicable to other types of messages that may be sent by a business entity and that may relate to different services/resources 116 available from a service provider 102.

Business entities are associated with notification campaigns (block 502). In particular, an ad service 106 may manage subscriptions to notifications campaigns as previously discussed. An ad database 130 or other suitable database/storage may be configured to include campaign data 204 that describes campaigns, associations of business entities to the campaigns, authorizations for the campaigns, message selection criteria, and so forth.

A message is received for delivery to a client (block 504). For instance, a messaging service 118 may receive and process messages 120 as described herein to route the message and/or send notifications regarding the message. As part of processing a message, metadata associated with the message is parsed to ascertain a business entity corresponding to the message (block 506). For instance, the messaging service 118 may cause the message to be classified using various techniques. This may include examining one or more metadata fields and extracting identifying information, such as a sender identity, campaign ID, custom fields and the like. Using the information ascertained through processing the message, a determination is made regarding whether the business entity is associated with a campaign (block 508). Again, this may occur by referencing a campaign associated with the sender identity or campaign ID. This may also occur by parsing information contained in one or more custom fields that directly indicate notifications 126 to take place for a message 120.

If business entity is not associated with a campaign, the message delivery is initiated without notifications (block 510). If the business entity is associated with a campaign, a determination is made regarding whether the message is eligible for the campaign (block 512). Eligibility may be based upon message selection criteria included with a notification campaign. Message selection criteria may enable a business entity to set up a campaign to use notifications for some types of message and not others. Message selection criteria may be used to differentiate between different message based up the type of message, content of the message, keywords, custom fields, and/or other selection criteria. For example, promotional messages, product updates, and special event messages may be designated to use notifications 126, while purchase confirmations, shipment notices, and other transactional messages may be delivered without using notifications. Message selection criteria may be applied to select matching messages through classification operations, such as operations performed by a classification module 122 as described herein.

If the message is not eligible, the message delivery is initiated without notifications as per block 510. If the message is eligible, the message delivery is initiated and one or more notifications are sent according to the notification campaign associated with the business entity (block 514). Various notifications 126 may be sent using one or more notifications systems 206, including but not limited to the different example types of notifications 126 discussed previously.

Having considered examples procedures related to message notification campaigns, consider now example systems that may be employed to provide techniques for message notification campaigns in one or more embodiments.

Example System

FIG. 6 illustrates an example system generally at 600 that includes an example computing device 602 that is representative of one or more such computing systems and/or devices that may implement the various embodiments described above. The computing device 602 may be, for example, a server of a service provider 102, a device associated with the client 104, an on-chip system, and/or any other suitable computing device or computing system.

The example computing device 602 includes one or more processors 604 or processing units, one or more computer-readable media 606 which may include one or more memory and/or storage components 608, one or more input/output (I/O) interfaces 610 for input/output (I/O) devices, and a bus 612 that allows the various components and devices to communicate one to another. Computer-readable media 606 and/or one or more I/O devices may be included as part of, or alternatively may be coupled to, the computing device 602. The bus 612 represents one or more of several types of bus structures, including a memory bus or memory controller, a peripheral bus, an accelerated graphics port, and a processor or local bus using any of a variety of bus architectures. The bus 612 may include wired and/or wireless buses.

The memory/storage component 608 represents memory/storage capacity associated with one or more computer-readable media. The memory/storage component 608 may include volatile media (such as random access memory (RAM)) and/or nonvolatile media (such as read only memory (ROM), Flash memory, optical disks, magnetic disks, and so forth). The memory/storage component 608 may include fixed media (e.g., RAM, ROM, a fixed hard drive, etc.) as well as removable media (e.g., a Flash memory drive, a removable hard drive, an optical disk, and so forth).

Input/output interface(s) 610 allow a user to enter commands and information to computing device 602, and also allow information to be presented to the user and/or other components or devices using various input/output devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software, hardware (fixed logic circuitry), or program modules. Generally, such modules include routines, programs, objects, elements, components, data structures, and so forth that perform particular tasks or implement particular abstract data types. An implementation of these modules and techniques may be stored on or transmitted across some form of computer-readable media. The computer-readable media may include a variety of available medium or media that may be accessed by a computing device. By way of example, and not limitation, computer-readable media may include “computer-readable storage media” and “communication media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. Computer-readable storage media also includes hardware elements having instructions, modules, and/or fixed device logic implemented in a hardware form that may be employed in some embodiments to implement aspects of the described techniques.

The computer-readable storage media includes volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, hardware elements (e.g., fixed logic) of a integrated circuit or chip, or other storage device, tangible media, or article of manufacture suitable to store the desired information and which may be accessed by a computer.

“Communication media” may refer to a signal bearing medium that is configured to transmit instructions to the hardware of the computing device, such as via the network 108. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

Combinations of any of the above are also included within the scope of computer-readable media. Accordingly, software, hardware, or program modules, including the messaging service 118, communication module 136, classification module 122, notification module 124, resource manager module 114, and other program modules, may be embodied as one or more instructions and/or logic embodied on some form of computer-readable media.

Accordingly, particular modules, functionality, components, and techniques described herein may be implemented in software, hardware, firmware and/or combinations thereof The computing device 602 may be configured to implement particular instructions and/or functions corresponding to the software and/or hardware modules implemented on computer-readable media. The instructions and/or functions may be executable/operable by one or more articles of manufacture (for example, one or more computing devices 602 and/or processors 604) to implement techniques for message notification campaigns, as well as other techniques. Such techniques include, but are not limited to, the example procedures described herein. Thus, computer-readable media may be configured to store or otherwise provide instructions that, when executed by one or more devices described herein, cause various techniques for message notification campaigns.

Conclusion

Although message notification campaign techniques have been described in language specific to structural features and/or methodological acts, it is to be understood that the appended claims are not necessarily limited to the specific features or acts described. Rather, the specific features and acts are disclosed as example forms of implementing the message notification campaign techniques.

What is claimed is:

1. A method implemented by a computing system comprising:
obtaining a message for delivery to a client;
identifying a notification campaign that is associated with the message;
initiating delivery of the message to the client; and
notifying the client regarding the message via one or more notification systems according to the identified notification campaign.

2. A method as described in claim 1, wherein the message comprises an email message.

3. A method as described in claim 1, wherein notifying the client regarding the message comprises causing at least two different types of notifications to be sent to the client in addition to delivery of the message to the client.

4. A method as described in claim 1, wherein the one or more notification systems are configured to provide multiple different types of notifications to clients including toast messages, instant messages, home page notifications, and update feed notifications.

5. A method as described in claim 1, wherein:
initiating delivery of the message to the client comprises routing the message to a messaging account with a messaging service available from a service provider; and
notifying the client regarding the message comprises causing a notification to the client in conjunction with at least one other service available from the service provider.

6. A method as described in claim 1, wherein notifying the client regarding the message comprises causing multiple notifications to the client in conjunction with multiple services available from a service provider.

7. A method as described in claim 1, wherein identifying the notification campaign that is associated with the message comprises:
parsing metadata fields contained in the message to determine an identity of a sender of the message; and
using the identity of the sender of the message to ascertain the notification campaign that is associated with the message from a database storing associations of business entities to corresponding campaigns.

8. A method as described in claim 1, wherein identifying the notification campaign that is associated with the message comprises:
parsing metadata fields contained in the message to determine a campaign identifier included in the message; and
using the campaign identifier to look-up the notification campaign that is associated with the message.

9. A method as described in claim 1, wherein:
identifying the notification campaign that is associated with the message comprises extracting data from one or more metadata fields contained in the message to determine one or more types of notifications to take place for the message; and
notifying the client regarding the message comprises causing the one or more types of notifications that are determined to be sent via the one or more notification systems.

10. A method as described in claim 1, wherein identifying the notification campaign that is associated with the message comprises:
extracting data from one or more metadata fields contained in the message sufficient to determine a reputation for a sender of the message; and
selecting the notification campaign to use for the message based on the reputation.

11. One or more computer-readable storage media storing instructions that, when executed by a computing system, cause one or more devices of the computing system to implement a messaging service to perform operations comprising:
associating a business entity with a notification campaign defining one or more types of notifications to take place regarding messages sent by the business entity;
ascertaining that the business entity corresponds to a message received for delivery to a client by parsing metadata associated with the message; and
sending one or more notifications to the client regarding the message according to the notification campaign associated with the business entity.

12. One or more computer-readable storage media as described in claim 11, wherein parsing metadata associated with the message comprises examining one or more header fields of the message and extracting an identifier that identifies the business entity.

13. One or more computer-readable storage media as described in claim 11, wherein sending the one or more notifications to the client regarding the message comprises causing multiple notifications to the client in conjunction with multiple services available from a service provider in addition to delivery of the message to the client.

14. One or more computer-readable storage media as described in claim 11, wherein sending the one or more notifications to the client regarding the message comprises causing the one or more notifications to be sent via one or more notification systems configured to provide multiple different types of notifications to clients including toast messages, instant messages, home page notifications, and update feed notifications.

15. One or more computer-readable storage media as described in claim 11, wherein sending the one or more notifications to the client regarding the message comprises configuring a portion of user interface designed to provide interaction with resources available from a service provider over a network to display the one or more notifications in conjunction with the resources.

16. One or more computer-readable storage media as described in claim 11, wherein associating the business entity with a notification campaign comprises:
exposing a registration user interface to enable the business entity to purchase the notification campaign;
receiving selections from the business entity via the registration user interface to define the notification campaign; and
forming an association of the business entity with the notification campaign according to the selections.

17. A system comprising:
one or more processors; and
one or more computer-readable storage media storing instructions that, when executed via the one or more processors, cause the one or more processors to implement an messaging service configured to perform acts to send notifications regarding a message received from a business entity for delivery to a client including:
parsing one or more metadata fields included in the message to determine notifications regarding the message to take place via one or more notifications systems configured to enable at least two different types of notifications; and
causing the notifications regarding the message to be sent to the client via the one or more notifications systems in addition to delivery of the message to the client.

18. A system as described in claim 17, wherein the different types of notifications enabled by the one or more notification systems include toast messages, instant messages, home page notifications, update feed notifications, text messages, and voicemail messages.

19. A system as described in claim 17, further comprising:
routing the message to an account of the client with the messaging service available from a service provider,
wherein causing the notifications regarding the message to be sent to the client comprises providing at least one notification to the client in conjunction with at least one other services available from the service provider in addition to routing the message to the account of the client with the messaging service.

20. A system as described in claim 17, wherein parsing the one or more metadata fields included in the message to determine the notifications comprises:
extracting data from the one or more metadata fields sufficient to determine at least one of a sender identifier corresponding to the business entity or a campaign identifier included in the message; and
using at least one of the sender identifier or the campaign identifier to ascertain a notification campaign that is associated with the message and describes the notifications to take place regarding the message.
